(19) United States
(12) Patent Application Publication
(10) Pub. No.: US 2026/0044053 A1
(43) Pub. Date: Feb. 12, 2026

(54) Soft Cuculoris

(71) Applicant: Rosco Laboratories, Inc., Stamford, CT (US)

(72) Inventor: Philip Greenstreet, Pasadena, CA (US)

(21) Appl. No.: 18/800,258

(22) Filed: Aug. 12, 2024

(51) Int. Cl. G03B 15/02

(52) U.S. Cl. CPC G03B 15/02

(57) ABSTRACT

A cuculoris device including a panel with a first side, a second side, and an exterior edge surrounding an interior area of the panel. The interior area of the panel has one or more interior edges defining a plurality of at least two different sized apertures in the panel. A shape of the one or more interior edges corresponds to a pattern. The plurality of at least two different sized apertures configured to permit light to pass, and the panel material is configured to block light, such that when light is directed toward the first side of the panel, the light passing through to the second side of the panel is projected according to the pattern. At least a portion of the panel is made from a material that is pliable so that the panel can be rolled or folded for easy transport from one set to another.

### TECHNICAL FIELD

The present disclosure relates generally to a cuculoris, and more particularly to a cuculoris cut from a soft material such as fabric using a fabric-cutting machine and a method of making the same.

### BACKGROUND

A cuculoris is a device that is positioned in between a lamp and a subject being filmed or photographed so that the light emitted by the lamp is patterned or textured. It is commonly used in the film industry to create a more natural look to a set by rendering the light cast by a lighting fixture to appear similar to, e.g. light from the sun filtering through the leaves of a tree.

Previous techniques of texturing or patterning the light from a lamp include using camouflage nets. However, this produces unrealistic images where it is apparent that a net is actually casting the shadow. Previous techniques also include the use of a gobo, which is similar to a cuculoris but differs in that it is held very close to the light to create a more defined pattern of light. Because gobos are held so close the light, they are generally made from a rigid material capable of withstanding high heat, like metal. In addition, their close proximity to the light source makes gobos useful for projecting light with fine detail, for example, to project a logo on a wall. However, this same feature makes gobos a poor tool for producing lighting having a natural character incorporating soft edges. For example, gobos cannot realistically generate light that appears similar to sunlight filtering through the leaves of a tree. This is why a cuculoris device is used in these situations.

Prior cuculoris devices have been made from sheets of plywood or other rigid materials but this yields unsatisfactory results because the images produced by these types of cuculoris devices are low fidelity, with shadows that look like blobs. Traditional cuculoris devices are also difficult to transport as they cannot be folded, and are difficult to cut or create, making experimentation and customization an arduous and oftentimes unfeasible process.

Aspects of the present invention are directed to these and other problems.

### SUMMARY

According to an aspect of the present invention, a cuculoris device includes a panel with a first side, a second side, and an exterior edge surrounding an interior area of the panel. The interior area of the panel has one or more interior edges defining a plurality of at least two different sized apertures in the panel, a shape of the one or more interior edges corresponding to a pattern. The plurality of at least two different sized apertures are configured to permit light to pass, and the panel material is configured to block light, such that when light is directed toward the first side of the panel the light passing through to the second side of the panel is projected according to the pattern. At least a portion of the panel is pliable material so that the panel can be rolled or folded for easy transport from one set to another.

According to another aspect of the present invention, a patterned light generating system includes pattern information encoding a pattern configured to produce patterned light. A fabric-cutting machine for receiving the pattern information and cutting material into the fabric-cutting machine according to the pattern information. A cuculoris device output by the fabric-cutting machine, the cuculoris device having a first side, a second side, and an exterior edge surrounding an interior area, and the interior area of the cuculoris device having one or more interior edges defining a plurality of at least two different sized apertures in the cuculoris device. A light source disposed adjacent to the cuculoris device, the light source producing unpatterned light directed toward the first side of the cuculoris device. The plurality of at least two different sized apertures are configured to permit light to pass, and the material of the cuculoris device is configured to block light, such that the patterned light emerges from the second side of the cuculoris device.

In addition to, or as an alternative to, one or more of the features described above, further aspects of the present invention can include one or more of the following features, individually or in combination:

-the one or more interior edges of the panel comprises a first interior edge portion and a second interior edge portion, and the first interior edge portion opposes the second interior edge portion;
the first interior edge portion is separated from the second interior edge portion by a distance, and the distance varies along the plurality of at least two different sized apertures;
the first interior edge portion has a first radius of curvature, and the second interior edge portion has a second radius of curvature, and the first radius of curvature is not equal to the second radius of curvature;
the first interior edge portion is substantially parallel to the second interior edge portion;
the panel material is at least one of woven fabric and non-woven fabric;
the panel material is heat-resistant;
the panel material is flame retardant
the panel is rectangular in shape;
the panel is mounted on a net;
the panel is substantially flat and planar;
the light source is separated from the cuculoris device by a separation distance, and the separation distance is in the range of 5 cm to 500 cm;
the pattern is repeated;
the cuculoris device is rectangular in shape with each side having a length in the range of 10 cm to 500 cm;
the cuculoris device is mounted to a net;
the material of the cuculoris device is at least one of woven fabric and non-woven fabric;
the material of the cuculoris device is heat-resistant;
the cuculoris device is substantially flat and planar;
the patterned light produced by the cuculoris device resembles sunlight passing through foliage;
the patterned light produced by the cuculoris device resembles sunlight as it appears from a perspective underneath the surface of water;
a movement of the light source relative to the cuculoris device or a movement of the cuculoris device relative to the light source causes a change in the angle of the patterned light.
the first side of the panel has a light finish for preventing heat build up;
the rear side of the panel has a dark finish for preventing reflections to the camera;
the patterned light produced by the cuculoris resembles sunlight or artificial light passing through architectural or industrial artifacts;
the possibility exists to use multiple cuculorii to create a layered effect.

These and other aspects of the present invention will become apparent in light of the drawings and detailed description provided below.

### BRIEF DESCRIPTION OF THE DRAWINGS

FIG. 1 illustrates a perspective view of a cuculoris device being used according to the present disclosure.

FIG. 2A illustrates a plan view of the cuculoris device shown in FIG. 1.

FIG. 2B illustrates a cross-sectional elevation view of the cuculoris device shown in FIG. 2A.

FIG. 3 is a schematic demonstrating the functioning of the cuculoris device according to the present disclosure.

FIG. 4 is a block diagram of a cuculoris system incorporating the cuculoris device of FIG. 1.

FIG. 5 is a flowchart illustrating a process of making and using the cuculoris of FIG. 1.

### DETAILED DESCRIPTION

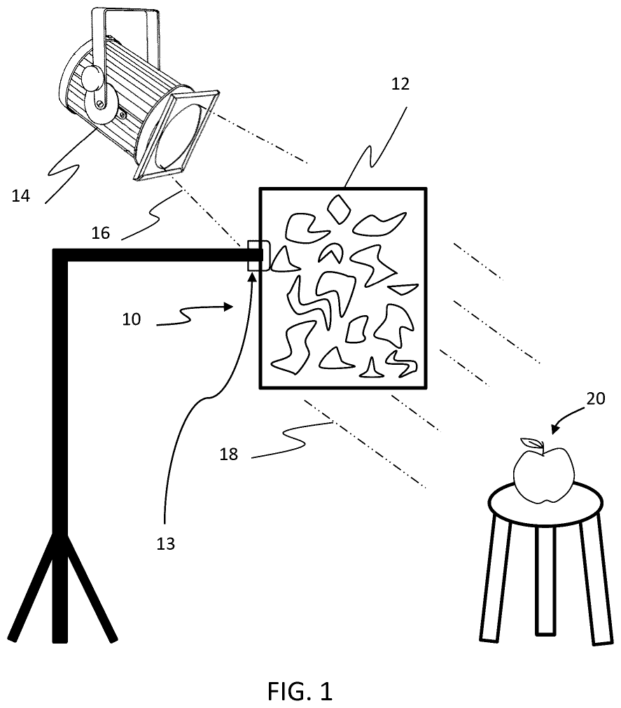

Referring to FIG. 1, the present disclosure describes a cuculoris device 10. The cuculoris device 10 includes a panel 12, which has a light source 14 producing unpatterned light 16 directed toward the cuculoris device 10. Some of the unpatterned light 16 is blocked by the cuculoris device 10, and some of the unpatterned light 16 passes through the cuculoris device 10 and forms patterned light 18. The patterned light 18 is incident on a subject 20.

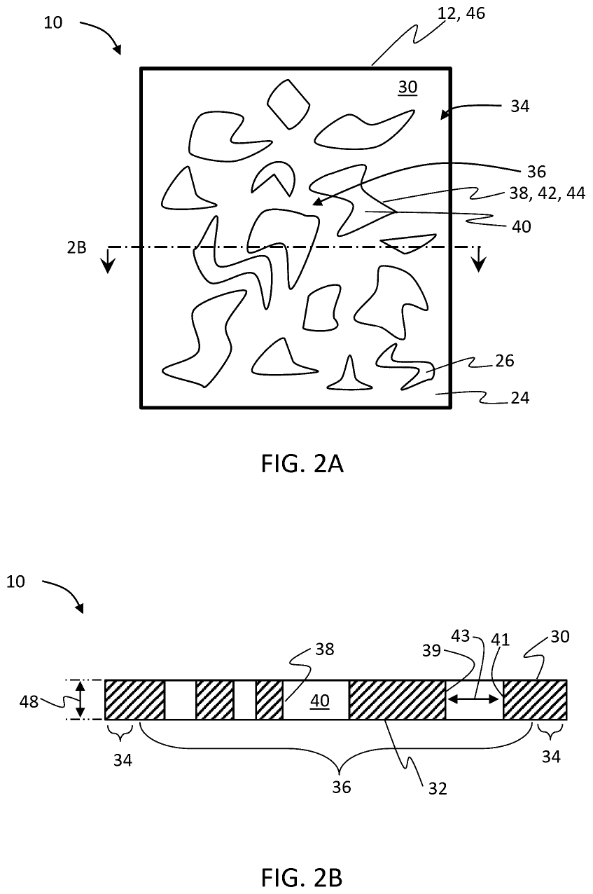

Referring to FIG. 2A, the cuculoris device 10 is shown with a panel 12, having a first side 30, a second side 32 (not shown), an exterior edge 34, surrounding an interior area 36 of the panel 12. The interior area 36 of the panel has one or more interior edges 38 defining a plurality of at least two different sized apertures 40 in the panel 12. A shape 42 of the one or more interior edges 38 corresponds to a pattern 44. The plurality of at least two different sized apertures 40 are configured to permit light to pass through it. The panel 12 is made from a material 46 that is opaque, and is designed to block light emitted by the light source 14. Thus, when light source 14 emits unpatterned light 16 toward the first side 30 of the panel 12, the unpatterned light 16 that passes through to the second side 32 of the panel 12 is projected according to the pattern 44, creating patterned light 18. The panel 12 may be any suitable dimension, but preferably is rectangular, flat, and planar. In another example, the panel 12 can be triangular, circular, or any polygonal shape, and may comprise multiple parts or portions joined together, and may have wrinkles or folds or bends formed therein. In one example, the panel 12 is mounted on a mount 13 which may be a net or similar material known by those of skill in the art having the benefit of the present disclosure. In one example, the cuculoris device 10 is approximately rectangular with sides in the range of 10 cm to 500 cm, or 50 cm to 200 cm, or 100 cm to 250 cm, or 220 cm to 270 cm.

At least a portion of the panel 12 is made from a material 46 that is pliable so that the panel 12 can be rolled or folded for easy transport from one set to another. In one example, the material 46 may be any one of a woven fabric, unwoven fabric, cotton, wool, polyester, nylon, polymer, metal, and/or have heat-resistant properties, be coated or treated to alter its properties, or any other properties known by those of skill in the art having the benefit of the present disclosure. The heat-resistant properties of the material 46 allow the cuculoris device 10 to be placed very close to a light source 14 without having to worry about de-configuration or a fire-hazard. In one example, the light source 14 is an LED light or other non-heat emitting light known by those of skill in the art, and thus the material 46 need not necessarily have heat-resistant properties. In another example, the light source 14 may be sunlight.

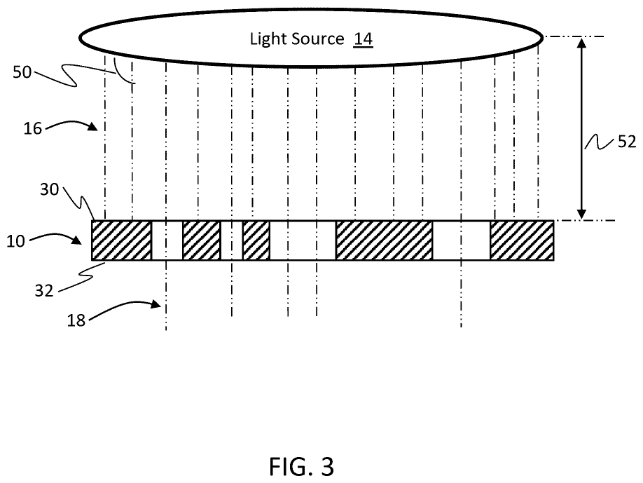

Referring to FIG. 2B, the cuculoris device 10 of FIG. 2A is shown in a cross-sectional view along line 2B shown in FIG. 2A. The cuculoris device 10 has a panel 12, having a first side 30, a second side 32, an exterior edge 34, surrounding an interior area 36 of the panel 12. The interior area 36 of the panel 12 has one or more interior edges 38 defining a plurality of at least two different sized apertures 40 in the panel 12. The one or more interior edges 38 has a first interior edge portion 39 and a second interior edge portion 41 opposing the first interior edge portion 39, separated by a distance 43 which may vary along the plurality of at least two different sized apertures 40. The panel 12 has a thickness 48. In one example, the thickness 48 of the panel 12 can be varied to impact the sensitivity of the patterned light 18 to changes in the angle 50 (see FIG. 3) of the unpatterned light 16 directed toward the cuculoris device 10.

Referring to FIG. 3, the light source 14 emits unpatterned light 16 at an angle 50 toward the cuculoris device 10. The plurality of at least two different sized apertures 40 allows the unpatterned light 16 to pass through while the panel 12 substantially blocks the unpatterned light 16 incident upon the first side 30 of the panel 12. As a result, patterned light 18 emerges from the second side 32 of the panel 12. The light source 14 is separated from the cuculoris device 10 by a separation distance 52. In one example, the separation distance 52 is in the range of 5 cm to 500 cm, 50 cm to 100 cm, 75 cm to 200 cm, or 150 cm to 300 cm.

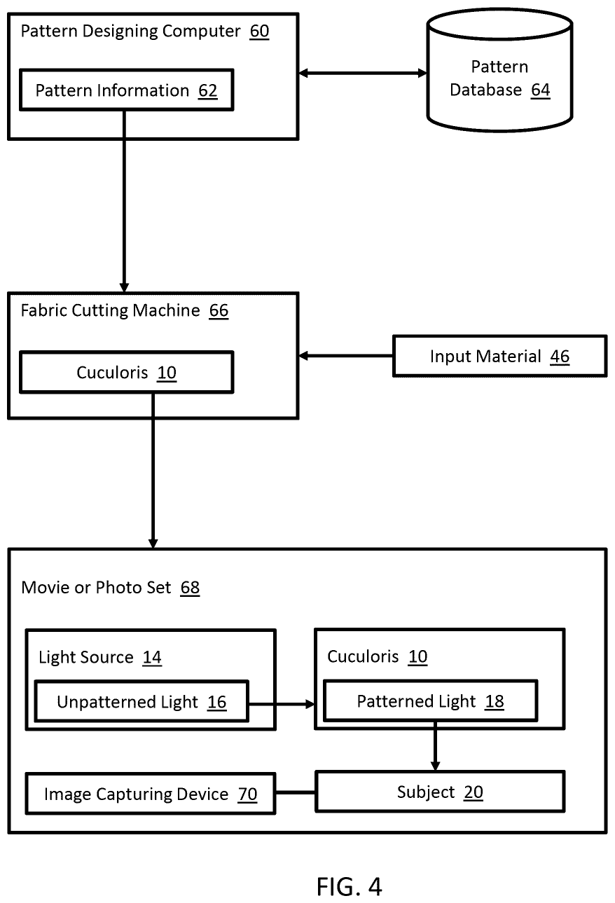

Referring to FIG. 4, a block diagram showing a system for making and using a cuculoris device 10 is shown. A pattern designing computer 60 is used to generate or code pattern information 62. The pattern information 62 may be stored in a pattern database 64 for later retrieval, or sent directly to a fabric cutting machine 66. The fabric cutting machine 66 uses the pattern information 62 received from the pattern designing computer 60 to cut input material 46 fed into the fabric cutting machine 66, in order to produce the cuculoris device 10. The pattern designing computer 60 may contain software or other methods to design or receive a pattern. Therefore, the pattern information 62 may be computer or human generated. The cuculoris device 10 may be used, by way of a non-limiting example, in a movie or photo set 68. A light source 14 sends (emits) unpatterned light 16 onto the cuculoris device 10 to produce patterned light 18. The patterned light 18 is projected onto the subject 20 which is the subject of the image capturing device 70. In one example, the pattern information 62 may be a computer file that is sent to the fabric cutting machine 66. In another example, the fabric cutting machine 66 is computer-controlled, and the computer 60 receives the pattern information 62. The fabric cutting machine 66 can be a laser-cutting device, sawing device, shearing device, or any other device known by those of skill in the art having the benefit of the present disclosure.

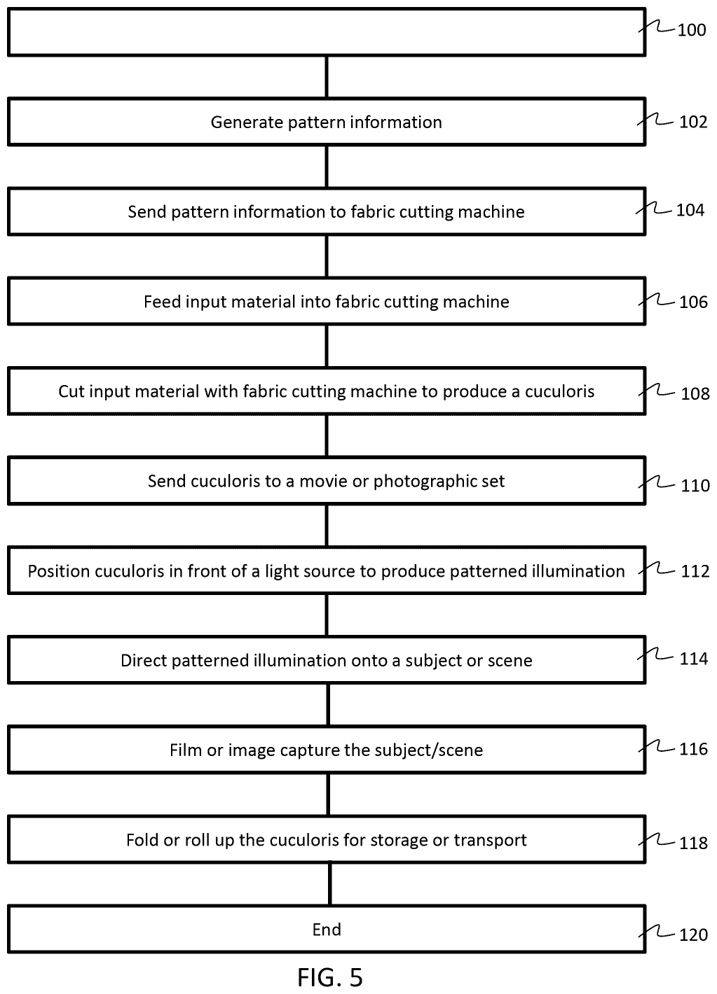

Referring to FIG. 5, a flowchart illustrating a process of making and using a cuculoris device 10 is shown. The method begins at the start 100. In a first step of the method, pattern information 62 is generated 102. The pattern information 62 is sent to a fabric cutting machine 66, 104. Input material 46 is fed into the fabric cutting machine 66, 106. The input material 46 is cut according to the pattern information 62 to produce a cuculoris device 10, 108. The cuculoris device 10 is sent to a movie set or photographic shoot 68, 110. The cuculoris device 10 is positioned in front of a light source 14 to produce patterned illumination 18, 112. The patterned illumination 18 is directed toward a subject or scene 20, 114. The subject or scene 20 is filmed or photographed 116. Once the shoot is complete, the cuculoris device 10 is folded or rolled up for storage or transport 118. The method is then ended 120.

The cuculoris device 10 offers several advantages over known systems and devices. By forming the cuculoris device 10 from a material 46 that is soft and/or flexible, the cuculoris device 10 can be folded or rolled up for easy transport from one place to another, or easily disposed of once no longer needed. It also is easier to produce using cheaper, smaller, and more readily available equipment and technology. The heat-resistant and flame retardant properties of the material 46 allows the cuculoris device 10 to be placed very close to the light source 14 without risking de-configuration or creating a fire-hazard, providing an advantage over other cuculoris devices. In addition, by cutting the cuculoris device 10 from fabric or cloth, the cuculoris device 10 is relatively lightweight, providing an advantage over prior art devices. In addition, cutting the cuculoris device 10 from a flexible material 46 such as cloth also provides an advantage since cloth can easily be manipulated, positioned, or fluttered with a fan/air flow to create a variety of effects on the patterned light 18 produced by the cuculoris device 10. As an example, by placing a fan near the cuculoris device 10, the cuculoris device 10 can be made to flutter to create patterned light 18 similar in character to sunlight filtering through the leaves of a tree blowing in the wind. This technique can be combined with variations in the thickness 48 of the panel 12 as described above, e.g. by increasing the height 48 of the panel 12, the patterned light 18 is made relatively more sensitive to fluttering of the panel 12 from air blowing on the cuculoris device 10.

While several embodiments have been disclosed, it will be apparent to those of ordinary skill in the art that aspects of the present invention include many more embodiments and implementations.

Accordingly, aspects of the present invention are not to be restricted except in light of the attached claims and their equivalents. It will also be apparent to those of ordinary skill in the art that variations and modifications can be made without departing from the true scope of the present disclosure. For example, in some instances, one or more features disclosed in connection with one embodiment can be used alone or in combination with one or more features of one or more other embodiments.

What is claimed is:

1. A cuculoris device, comprising:
a panel with a first side, a second side, and an exterior edge surrounding an interior area of the panel;
wherein the interior area of the panel has one or more interior edges defining a plurality of at least two different sized apertures in the panel;
a shape of the one or more interior edges corresponding to a pattern;
the plurality of at least two different sized apertures are configured to permit light to pass, and the panel is configured to block light, such that when light is directed toward the first side of the panel the light passing through to the second side of the panel is projected according to the pattern; and
at least a portion of the panel is pliable material.

2. The cuculoris device of claim 1, wherein the one or more interior edges of the panel comprise a first interior edge portion and a second interior edge portion, and the first interior edge portion opposes the second interior edge portion.

3. The cuculoris device of claim 2, wherein the first interior edge portion is separated from the second interior edge portion by a distance, and the distance varies along the plurality of at least two different sized apertures.

4. The cuculoris device of claim 3, wherein the first interior edge portion has a first radius of curvature, and the second interior edge portion has a second radius of curvature, and the first radius of curvature is not equal to the second radius of curvature.

5. The cuculoris device of claim 2, wherein the first interior edge portion is substantially parallel to the second interior edge portion.

6. The cuculoris device of claim 1, wherein the panel material is at least one of woven fabric and non-woven fabric.

7. The cuculoris device of claim 1, wherein the panel material is heat-resistant.

8. The cuculoris device of claim 1, wherein the panel is rectangular in shape.

9. The cuculoris device of claim 1, wherein the panel is mounted on a net.

10. The cuculoris device of claim 1, wherein the panel is substantially flat and planar.

11. The cuculoris device of claim 1, wherein the pattern is repeated.

12. A patterned light generating system, comprising:
pattern information encoding a pattern configured to produce patterned light;
a fabric-cutting machine for receiving the pattern information and cutting material into the fabric-cutting machine according to the pattern information;
a cuculoris device output by the fabric-cutting machine, the cuculoris device having a first side, a second side, and an exterior edge surrounding an interior area, and the interior area of the cuculoris device having one or more interior edges defining a plurality of at least two different sized apertures in the cuculoris device; and
a light source disposed adjacent to the cuculoris device, the light source producing unpatterned light directed toward the first side of the cuculoris device;
wherein the plurality of at least two different sized apertures are configured to permit light to pass, and the material of the cuculoris device is configured to block light, such that the patterned light emerges from the second side of the cuculoris device.

13. The patterned light generating system of claim 12, wherein the light source is separated from the cuculoris device by a separation distance, and the separation distance is in a range of 5 cm to 500 cm.

14. The patterned light generating system of claim 12, wherein the cuculoris device is rectangular in shape with each side having a length in a range of 10 cm to 500 cm.

15. The patterned light generating system of claim 12, wherein the cuculoris device is mounted to a net.

16. The patterned light generating system of claim 12, wherein the material of the cuculoris device is at least one of woven fabric and non-woven fabric.

17. The patterned light generating system of claim 12, wherein the material of the cuculoris device is heat-resistant.

18. The patterned light generating system of claim 12, wherein the cuculoris device is substantially flat and planar.

19. The patterned light generating system of claim 12, wherein the patterned light produced by the cuculoris device resembles sunlight passing through foliage, bare branches, industrial structures, or other physical objects.

20. The patterned light generating system of claim 12, wherein the patterned light produced by the cuculoris device resembles sunlight as it appears from a perspective underneath a surface of water due to a partial refraction of sunlight on the surface of the water.

21. The patterned light generating system of claim 12, wherein a movement of the light source relative to the cuculoris device or a movement of the cuculoris device relative to the light source causes a change in an angle of the patterned light.
